(19) United States
(12) Patent Application Publication
(10) Pub. No.: US 2022/0290272 A1
(43) Pub. Date: Sep. 15, 2022

(54) Process for acquiring lithium from brine and for recovering lithium when recycling lithium ion accumulators

(71) Applicant: EnBW Energie Baden-Württemberg AG, Karlsruhe (DE)

(72) Inventors: Thomas Kölbel, Karlsruhe (DE); Elif Kaymakci, Waldbronn (DE); Laura Herrmann, Karlsruhe (DE); Magdalena Graczyk-Zajac, Heidelberg (DE)

(73) Assignee: EnBW Energie Baden-Württemberg AG, Karlsruhe (DE)

(21) Appl. No.: 17/690,645

(22) Filed: Mar. 9, 2022

(30) Foreign Application Priority Data
Mar. 10, 2021 (DE) 10 2021 105 808.2
Jul. 5, 2021 (DE) 10 2021 117 319.1

(51) Int. Cl. C22B 26/12; H01M 10/54; B01J 20/04; B01J 20/30; C22B 3/42

(52) U.S. Cl. CPC C22B 26/12; H01M 10/54; B01J 20/041; B01J 20/3042; C22B 3/42

(57) ABSTRACT

An adsorption process for acquiring lithium from brine, in which the desorption occurs with an eluent, whereby the eluent is a mixture of water and acetic acid and/or water and sodium peroxydisulfate and/or water and ammonium peroxydisulfate.

### CROSS REFERENCE TO RELATED APPLICATIONS

The present application relates and claims priority to German Patent Application Nos. 10 2021 105 808.2, filed Mar. 10, 2021, and 10 2021 117 319.1, filed Jul. 5, 2021, the entirety of each of which is hereby incorporated by reference.

### BACKGROUND

This invention describes a process for acquiring/recovering lithium ions from brine or seawater via adsorption. The brine may come from seawater desalination plants or deep geothermal wells or may be generated during the recycling of lithium-ion batteries.

Due to its advantages, such as high electrical energy density, high operational voltage, a long cyclical service life, lack of memory effect, etc., the rechargeable lithium ion battery (more precisely: lithium ion accumulator) is commonly used in notebook computers, mobile phones, and electric cars. The demand for lithium ion accumulators is growing rapidly, especially as electric mobility becomes more common. Lithium is present in such accumulators in the electrode material (solid) and in the electrolyte (liquid).

The accumulators reach the end of their service life after a few years and must be recycled.

The European Union stipulates binding minimum percentages for the recycling of lithium in its Battery Directive: at least 35% as of 2026, and at least 70% in 2030.

There are currently two known recycling technologies for lithium ion accumulators.

These are hydrometallurgy and pyrometallurgy.

In short, hydrometallurgy means that the accumulators are disassembled, ground up, and the ground material is subsequently filtered. Plastics and metals are usually recovered during this filtration.

Other resources contained within the ground material can be dissolved with an acid (usually sulfuric acid). This step is also referred to as “leaching”.

The dissolved resources are now in liquid form and should be separated from this liquid as effectively as possible so that, at the end of the separation process, the lithium in particular is present in a relatively pure state. This step is referred to as “separation”. The efficiency of the separation should be great enough that the separated substances can be used to produce new accumulators (battery grade).

Pyrometallurgy means that the accumulators are placed in a furnace. The flammable components of the ground material burn, and various metals are recovered. What remains is a slag containing the lithium and aluminum.

From this slag, the lithium is dissolved with acids, such as a mixture of sulfuric and muriatic acid, or via a hydrothermal process. This step is also referred to as “leaching”. Lithium is present in this acidic, watery solution (brine) in an ionic state, e.g., as lithium sulfate.

At the end of this recycling process, the dissolved resources, in particular the lithium, are present in liquid form. It should be separated from this liquid as effectively as possible so that, at the end of the separation process, resources (and the lithium in particular) are present in a relatively pure state. This step is also referred to as “recovery”. The efficiency of the separation process should be great enough that the separated resources can be used to produce new accumulators (battery grade).

### SUMMARY OF THE INVENTION

The invention concerns the recovery of lithium from a watery acidic solution obtained through hydrometallurgy and pyrometallurgy.

This watery solution of salts, which contains lithium ions, is also referred to as “brine” with regard to the invention. In particular, groundwater and deep water as well as seawater or the “waste products” of seawater desalination plants fall under the term “brine” in the sense of the invention.

In order to be able to produce lithium salts from a brine containing only few lithium ions (typically 10 to 1000 mg/L), the concentration thereof should be 15,000 ppm or greater. There is thus great interest in developing a process for increasing the lithium-ion concentration of the brine to a level required for the production of lithium salts.

U.S. Pat. No. 6,764,584 B2 describes a process for the adsorption of lithium ions from a watery solution (brine) containing lithium ions via adsorption. The process comprises the contacting of a watery solution containing lithium with an adsorption agent made from manganese oxide, also containing lithium, so that lithium ions in the watery solution are adsorbed by the adsorption agent. The brine is then drained and the lithium ions adhering to the adsorption agent are desorbed by a mixture of water and muriatic acid (HCl). This makes it possible to achieve an acidic solution with a lithium concentration of about 1500 ppm. The lithium concentration of the acidic solution is then further increased via two-step electrolysis, so that a lithium concentration suitable for producing lithium salts, specifically a concentration of about 15,000 ppm or more, can be achieved.

The invention aims to facilitate a process with which the brine obtained for example from the recycling of lithium ion accumulators can be effectively and separated in a relatively pure state in a cost-effective manner through the use of consumable materials. The process is also suitable for the extraction of lithium from brines of other origins.

The invention achieves this with a process for producing a lithium concentrate from brine containing lithium ions, and comprising the following steps:

introduction of brine into an adsorption column that is at least partially filled with an adsorption agent, so that lithium ions are absorbed by the adsorption agent;

expulsion of the brine from the adsorption column;

introduction of an eluent (solvent used for eluting) into the adsorption column so that the lithium ions adsorbed by the adsorption agent are desorbed, and characterized in that the eluent (before introduction into the adsorption column) is a mixture containing water and acetic acid and/or water and sodium peroxydisulfate and/or water and ammonium peroxydisulfate.

The use of these three eluents results in less effective desorption of the lithium ions than when muriatic acid is used; however, the dissolution of the adsorption agent is multiple magnitudes less than when muriatic acid or an acidic solution based on muriatic acid is used.

Tests have shown that each desorption step with a muriatic acid-based acidic solution causes dissolution of the adsorption agent of up to 5%. When using an eluent based on water and acetic acid, the dissolution of the adsorption agent is multiple magnitudes less. In other words, in tests with all three solutions described by the invention, loss was only about 1/100 of the loss when a muriatic-acid based acidic solution is used!

Because the adsorption agent is a relatively expensive product, the use of the acetic acid or sodium peroxydisulfate or ammonium peroxydisulfate solution increases the profitability of the process, in spite of the poorer desorption rate. The lower efficiency compared to the precedented process based on muriatic acid is economically insignificant, as the lithium ions accumulated in the adsorption agent are not “lost”, but rather entirely or partially desorbed in a subsequent desorption step.

Another advantage of using the eluents described by the invention is that they are very affordable, easier to use, and less dangerous. This makes the use of the aforementioned solutions particularly beneficial.

With the process described by the invention, lithium suitable for the production of new lithium ion accumulators can be recovered (or acquired). It facilitates real recycling management of lithium without compromising quality. As a result, the adsorption process described by the invention is profitable and easy to use.

It has been determined that concentrations or proportions of the acetic acid, sodium peroxydisulfate, or ammonium peroxydisulfate in the areas where they are described in the sub-claims 2 to 4 facilitate particularly profitable operation.

Furthermore, in a beneficial variant of the invention, the desorption process is conducted at a temperature between 50° C. and 70° C., preferably 60° C.

It has also been determined that with progressively higher temperatures during the desorption process facilitate greater effectiveness. Temperature management described by the invention, in particular with an additional desorption process at lower temperatures, can further increase profitability.

Furthermore, an expanded variant of the process described by the invention makes it possible to repeat the desorption step once or multiple times. This means that the solution containing lithium ions passes through the adsorption column once more following the first desorption step and then goes through a second desorption step, whereupon further lithium ions accumulated or adsorbed by the adsorption agent can be expelled. This considerably increases the desorption rate. However, the loss of adsorption agent is still very low compared to the precedented process.

If the brine contains other ions, such as sodium, potassium, calcium, and/or magnesium, then these accumulate in the adsorption agent (albeit in lower concentrations), which is not desired. Introducing water to the adsorption column has proven effective in removing these ions from the adsorption agent before desorption of the lithium ions. The water desorbs the aforementioned ions, but not the lithium ions, so that only lithium ions are desorbed in the following desorption step with the solution described by the invention, and the resulting lithium-rich solution has a very high degree of purity. This simplifies the reprocessing into lithium carbonate or pre-production of batteries or similar products.

Adsorption agents comprising manganese oxide, lithium titanium oxide (LiTiO), and/or lithium-aluminum layered double hydroxide chloride (LiAn.2xAl(OH)₃.mH₂O, with “An”=chlorine (Cl), bromine (Br), or iodine (I), “m” is a numerator), are particularly suitable for conducting the process described by the invention. Polymers have proven to be effective bonding agents. Polyvinyl chloride is a particularly effective bonding agent.

The process described by the invention can be used very effectively when the brine containing lithium stems from pyrometallurgic recycling of lithium ion accumulators. The brine then contains the lithium in addition to sodium, aluminum, and manganese, which should be separated from the lithium.

The process described by the invention can also be used very effectively when the brine containing lithium stems from hydrometallurgic recycling of lithium ion accumulators. The brine then contains the lithium in addition to vestiges of graphite, cobalt, nickel, manganese, and aluminum.

The composition of the brine stemming from the recycling of lithium ion accumulators is usually less complex than that from seawater desalination devices or that conveyed from geothermal deep boring. With the aid of the process according to the invention, the lithium can also be recovered from these lithium-containing brines. But, the selective adsorption of lithium from brine stemming from pyrometallurgy or hydrometallurgy described by the invention is even more effective, and the purity of the acquired lithium is greater.

Further advantages and beneficial variants of the invention can be found in the following illustration, its description, and the claims. All characteristics listed in the illustration, description, and claims can be pertinent to the invention either individually or in any combination with one another.

### BRIEF DESCRIPTION OF THE FIGURES

The figures show the following:

FIG. 1 a flow diagram of a process described by the invention, and

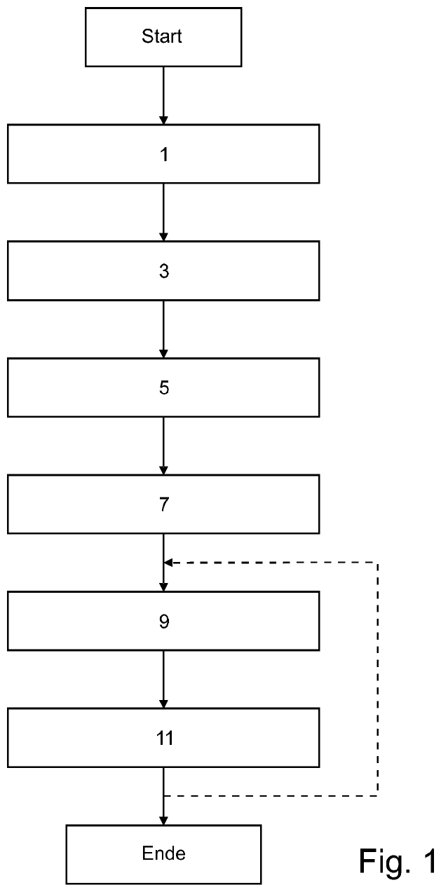

FIG. 2 a simplified view of an adsorption column suitable to conduct the process described by the invention.

### DETAILED DESCRIPTION

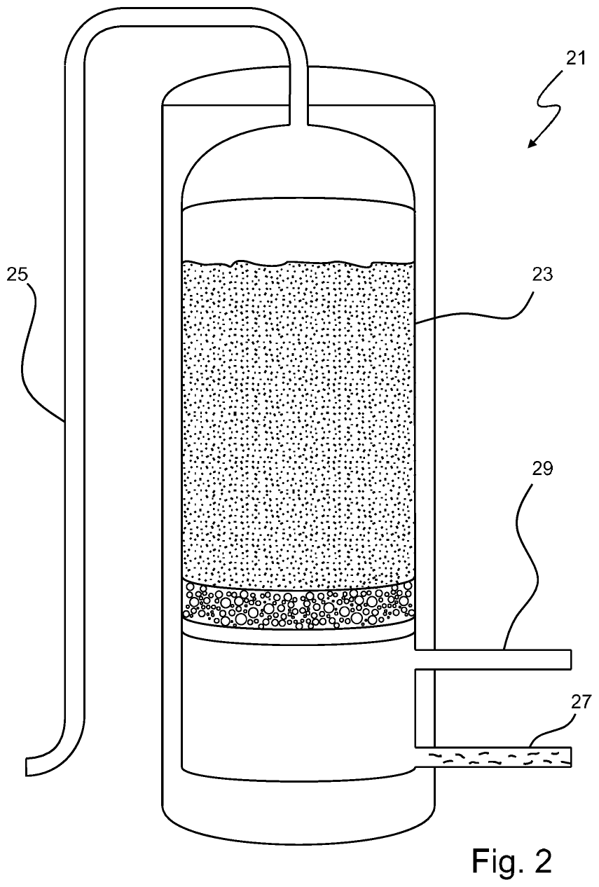

The process described by the invention is conducted with an adsorption column 21 as shown in FIG. 2.

The process described by the invention begins in a first step 1, in which the adsorption column 21 is filled with water. The adsorption column 21 contains an adsorption agent 23 that adsorbed the lithium ions in the brine. If further ions are contained in the brine, at least some of these ions are also adsorbed by the adsorption agent.

The brine is then expelled from the adsorption column 21 in another step (block 3).

In further, additional steps 5 or 7, the adsorption column 21 is filled with water and the water is then expelled from the adsorption column 21. The water is used to dissolve and desorb non-lithium ions that have been adsorbed by the adsorption agent. Otherwise these ions contaminate the acidic solution enriched with lithium ions. It is thus beneficial if these ions are desorbed before the desorption of the lithium ions. If the brine led to the adsorption column 21 contains only very few or none of these contaminants, steps 5 and 7 can be omitted.

The lithium ions adsorbed by the adsorption agent 23 are then desorbed (steps 9 and 11). Block 9 comprises the filling of the adsorption column 21 with an acidic solution as per claim 1. Most of the lithium ions adsorbed by the adsorption agent are thus desorbed. A certain proportion of the lithium ions remain in the adsorption agent, however.

In a further step 11, the eluent enriched with lithium ions is expelled.

Depending on the effectiveness of the desorption process, steps 9 and 11 can be repeated once or multiple times. The adsorption column 21 is thus filled with the acidic solution from the previous desorption step, in which it was enriched with lithium ions, whereupon it is expelled again. These repetitions can be performed until an optimal ratio between the loss of adsorption agent and maximization of the desorption of the lithium ions is achieved. It must be considered that only about 0.4% of the adsorption agent is lost during each desorption process with the acidic solution described by this invention. It is thus possible to perform steps 9 and 11 two or three times. Even then, the loss of adsorption agent only amounts to about 0.8% or 1.2%. This is only a fraction of the loss resulting from desorption with an acidic solution based on muriatic acid. In the latter case, each desorption step results in loss of about 5% of the adsorption agent.

Following desorption (steps 9 and 11), the acidic solution enriched with lithium ions may be further concentrated. For example, this may be the case with multi-step electrolysis, as described in U.S. Pat. No. 6,764,584 B2. The resulting, relatively highly concentrated acidic solution can then be further processed into a precursor for the production of lithium ion batteries.

It has been discovered that the desorption process is sufficiently effective even at decreasing temperatures. It is thus beneficial if the acidic solution is conveyed into the adsorption column 21 a second time at low temperatures, such as 40° C. or 30° C., or even lower.

FIG. 2 shows the design of an adsorption column 21 suitable for conducting the process.

The interior of the adsorption column 21 contains the adsorption agent. It does not take up the entire interior of the adsorption column 21.

The adsorption column 21 comprises an inlet 25 and an outlet 27. The brine is supplied via the inlet 25 and expelled via the outlet 27.

The acidic solution can be supplied and expelled via the inlet 25 or the outlet 27. However, it is also possible for an additional connection 29 to be used for the supply and expulsion of the acidic solution. This connection 29 can, as shown in FIG. 2, be located at the bottom of the adsorption column 21. But it can also be located at the top of the adsorption column 21 (not pictured.)

In short: The process described by the invention can be conducted if the desorption agent is supplied to the adsorption column 21 from the top or the bottom.

The required pumps and valves are not pictured in FIG. 2.

What is claimed is:

1. Process for producing a lithium concentrate from brine, containing lithium ions, comprising the following steps:
a) introduction of brine into an adsorption column at least partially filled with an adsorption agent so that lithium ions are adsorbed by the adsorption agent;
b) introduction of an eluent into the adsorption agent so that the lithium ions adsorbed by the adsorption agent are desorbed,
characterized in that, before introduction into the adsorption agent, the eluent is a mixture of water and acetic acid and/or water and sodium peroxydisulfate and/or water and ammonium peroxydisulfate.

2. Process as per claim 1, characterized in that the proportion of acetic acid in the eluent is between 0.1% and 100%.

3. Process as per claim 1, characterized in that the proportion of ammonium peroxydisulfate in the eluent is between 0.05% and 65%.

4. Process as per claim 1, characterized in that the proportion of sodium peroxydisulfate in the eluent is between 0.05% and 60%.

5. Process as per claim 1, characterized in that it also takes place at a temperature below 70° C.

6. Process as per claim 1, characterized in that the process step “b) introduction of the eluent” is repeated one or more times, and that during the repetition(s) the acidic solution containing lithium ions from the previous desorption step is used.

7. Process as per claim 6, characterized in that the repetition of the process step “b) introduction of the eluent” takes place at a lower temperature than the first time the process step “b)” is performed.

8. Process as per claim 1, characterized in that, between the process steps “a) introduction of the brine” and “b) introduction of the eluent”, there is an interim step, namely “introduction of water into the adsorption agent”, so that Na, K, Ca and Mg ions adsorbed by the adsorption agent are desorbed and transported from the adsorption column with the drainage of the water.

9. Process as per claim 1, characterized in that the adsorption agent comprises manganese oxide containing lithium, as well as a polymer as a bonding agent.

10. Process as per claim 1, characterized in that the adsorption agent comprises lithium titanium oxide (LiTiO), and/or lithium-aluminum layered double hydroxide chloride (LiAn.2xAl(OH)₃.mH₂O, with “An”=chlorine (Cl), bromine (Br), or iodine (I), “m” is a numerator) and a polymer as a bonding agent.

11. Process as per claim 9, characterized in that the bonding agent is polyvinyl chloride.

12. Process as per claim 1, characterized in that the brine stems from a pyrometallurgic recycling process of lithium ion accumulators.

13. Process as per claim 1, characterized in that the brine stems from a hydrometallurgic recycling process of lithium ion accumulators.
